(19) United States
(12) Patent Application Publication
(10) Pub. No.: US 2026/0270823 A1
(43) Pub. Date: Sep. 10, 2026

(54) METHOD AND APPARATUS FOR CARRIER SWITCH IN CELL IN MOBILE COMMUNICATIONS

(71) Applicant: MEDIATEK INC., Hsinchu City (TW)

(72) Inventors: Yi-Ju LIAO, Hsinchu City (TW); Pei-Kai LIAO, Hsinchu City (TW); Chi-Hsuan HSIEH, Hsinchu City (TW); Wei-De WU, Hsinchu City (TW)

(21) Appl. No.: 19/166,214

(22) PCT Filed: Jun. 7, 2024
(86) PCT No.: PCT/CN2024/098067

§ 371 Date: Sep. 17, 2025

Related U.S. Application Data
(60) Provisional application No. 63/506,842, filed on Jun. 8, 2023.

(51) Int. Cl. H04W 36/08

(52) U.S. Cl. CPC H04W 36/08

(57) ABSTRACT

Various solutions for carrier switch in cell with respect to an apparatus in mobile communications are described. The apparatus may receive a configuration from a network node. The configuration may include a plurality of carriers associated with a cell. The apparatus may perform a communication with the network node according to at least one carrier associated with the cell. The communication may include at least one of a downlink reception and an uplink transmission. The apparatus may receive a carrier switch pattern or an indication associated with carrier switching from the network node. The apparatus may communicate with the network node according to the carrier switch pattern or the indication.

### CROSS REFERENCE TO RELATED PATENT APPLICATION(S)

The present disclosure is part of a non-provisional application claiming the priority benefit of U.S. Patent Application No. 63/506,842, filed 8 Jun. 2023, the content of which herein being incorporated by reference in its entirety.

### TECHNICAL FIELD

The present disclosure is generally related to mobile communications and, more particularly, to carrier switch in cell with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, logical cells and physical carriers are generally one-to-one mapping, which may cause issues and inefficiency in some scenarios. For example, in current carrier aggregation (CA) framework of NR, one carrier is associated with one cell. The complexity and overhead of layer-1 signaling may increase with the number of the pairs of carrier and cell, and the one-to-one mapping between carrier and cell may cause issues that impact the performance of spectrum aggregation.

Therefore, to enhance network flexibility and to solve some issues caused due to one-to-one mapping between carrier and cell, techniques of associating multiple carriers with one cell may be introduced. However, based on the current techniques of associating multiple carriers with one cell, uplink communication or downlink communication may only be performed via a fixed carrier, which may significantly limit the data rates of the communications.

Accordingly, how to increase the data rates of the communications based on multiple carriers with one cell become important issues in the newly developed wireless communication network, and there is an urgent need to provide proper schemes to increase the data rates of the communications based on multiple carriers with one cell.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to carrier switch in cell with respect to apparatus in mobile communications.

In one aspect, a method may involve an apparatus receiving a configuration from a network node. The configuration may include a plurality of carriers associated with a cell. The method may also involve the apparatus performing a communication with the network node according to at least one carrier associated with the cell. The communication may include at least one of a downlink reception and an uplink transmission. The method may also involve the apparatus receiving a carrier switch pattern or an indication associated with carrier switching from the network node. The method may also involve the apparatus communicating with the network node according to the carrier switch pattern or the indication.

In one aspect, a method may involve an apparatus transmitting a configuration to a user equipment (UE). The configuration may include a plurality of carriers associated with a cell. The method may also involve the apparatus performing a communication with the UE according to at least one carrier associated with the cell. The communication may include at least one of a downlink transmission and an uplink reception. The method may also involve the apparatus transmitting a carrier switch pattern or an indication associated with carrier switching to the UE. The method may also involve the apparatus communicating with the UE according to the carrier switch pattern or the indication.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, a configuration from a network node. The configuration includes a plurality of carriers associated with a cell. The processor may also perform operations comprising performing, via the transceiver, a communication with the network node according to at least one carrier associated with the cell. The communication may include at least one of a downlink reception and an uplink transmission. The processor may also perform operations comprising receiving, via the transceiver, a carrier switch pattern or an indication associated with carrier switching from the network node. The processor may also perform operations comprising communicating, via the transceiver, with the network node according to the carrier switch pattern or the indication.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to carrier switch in cell with respect to apparatus in mobile communications. According to the present disclosure, a number of possible solutions may be implemented separately or jointly. That is, although these possible solutions may be described below separately, two or more of these possible solutions may be implemented in one combination or another.

Regarding to the present disclosure, a network node may configure a plurality of carriers (i.e., component carriers identified by component carrier identifications) associated with one cell to a user equipment (UE). The UE may perform a communication with the network node according to at least one carrier of the plurality of carriers associated with the cell. More specifically, regarding the communication (e.g., uplink (UL) transmission/downlink (DL) reception from UE perspective and UL reception/DL transmission from network node perspective,) the UE may receive a carrier switch pattern or an indication associated with carrier switching from the network node and communicate with the network node according to the carrier switch pattern or the indication to maximize the data rate of the communication.

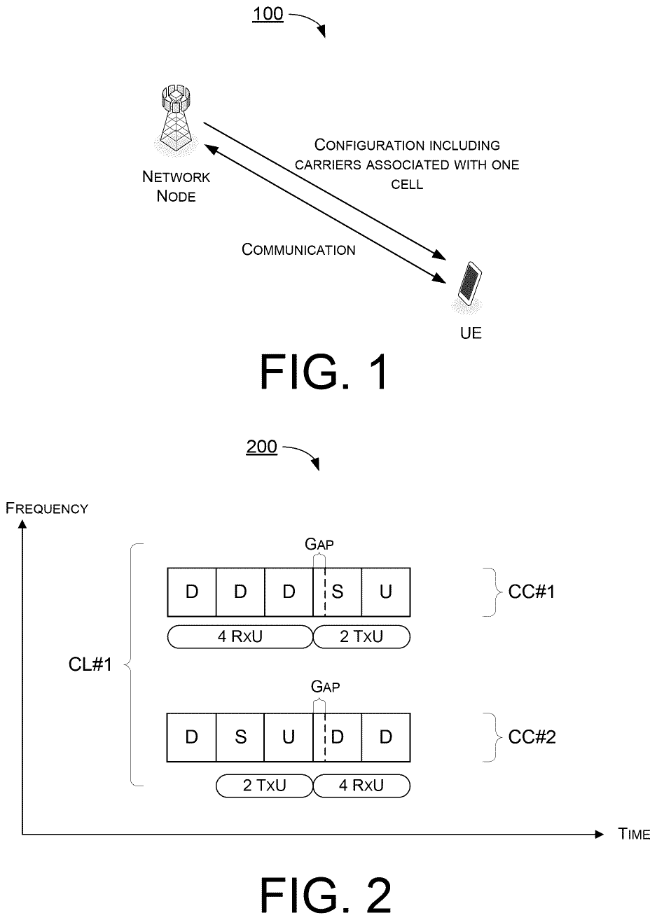

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a configuration to the UE. The configuration may include a plurality of carriers associated with a cell. In other words, the configuration may include parameters indicating the plurality of carriers associated with the cell. The network node may perform a communication (e.g., UL data transmission/DL data transmission from network perspective and UL data transmission/DL data reception from UE perspective) with the UE according to at least one carrier in the cell. The network node and the UE may receive a carrier switch pattern or an indication associated with carrier switching from the network node and communicate with the network node according to the carrier switch pattern or the indication.

In some implementations, the configuration may be included in a radio resource control (RRC) configuration. A number of the plurality of carriers associated with the cell may be greater than or equal to a maximum carrier number that the UE may be capable of using. In other words, the number of the plurality of carriers associated with the cell may be greater than or equal to the maximum carrier number of UE capability of the UE. For example, when the UE is capable of using two 100 MHz carriers based on the UE capability, the network configures the UE two or more than two 100 MHz carriers (e.g., four 100 MHz carriers) by the configuration.

In some implementations, a number of the at least one carrier associated with the cell, which are actually used for the communication, may be less than or equal to the maximum carrier number that the UE is capable of using. In other words, the number of carriers actually activated for the communication between the network node and the UE in the corresponding cell may be less than or equal to the maximum carrier number of UE capability of the UE. For example, when the UE is capable of using two 100 MHz carriers based on the UE capability, the activated 100 Mhz carriers are configured as two or less than two (e.g., two 100 MHz carriers).

For example, please refer to FIG. 2 which illustrates an example scenario 200 under schemes in accordance with implementations of the present disclosure. In particular, the UE may be compatible with techniques of multiple-input multiple-output (MIMO) and may have four receiving units (RxUs) and two transmitting units (TxUs). The network node may transmit the configuration to the UE. After receiving the configuration, the UE may be configured as four carriers CC #1 to CC #4 associated with one cell CL #1. Two carriers CC #1 and CC #2 may be used as activated carriers for the communication(s) between the network node and the UE. It should be noted that RxUs and TxUs may be independent hardware entities or different logical units of a hardware entity. However, it is not intended to limit the implementations of RxUs and TxUs.

Regarding a DL (transmission from network node perspective and reception from UE perspective,) the UE may utilize four RxUs to receive data from the network node via the carrier CC #1 within the first three slots (which are symbolized as “D”). Then, the UE may receive a carrier switch pattern or an indication from the network node and communicate with the network node according to the carrier switch pattern or the indication. More specifically, in this example, the UE may switch from the carrier CC #1 to the carrier CC #2, and then use four RxUs to receive data from the network node via the carrier CC #2 within the next two slots (which are symbolized as “D”). Carrier switch may happen during a gap.

Regarding an UL (transmission from UE perspective and reception from network node perspective,) the UE may utilize two TxUs to prepare and transmit data to the network node via the carrier CC #2 within last two of the first three slots (which are symbolized as “S” for data preparation and “U” for data uplink). Then, the UE may receive a carrier switch pattern or an indication from the network node and communicate with the network node according to the carrier switch pattern or the indication. More specifically, in this example, the UE may switch from the carrier CC #2 to the carrier CC #1, and then use two TxUs to prepare and transmit data to the network node via the carrier CC #1 within the next two slots (which are symbolized as “S” for data preparation and “U” for data uplink). Carriers switch may happen during a gap.

In some cases, the carriers switching gaps for DL transmission/reception and UL transmission/reception may be the same or different. In particular, the UE may report a capability for a length of carriers switching gap. The UE may report same length or different lengths for RxU and TxU. After receiving the capability, the network node may determine specific length(s) of carriers switching gap and transmit the specific length(s) of carriers switching gap to the UE for the UE to apply same or different specific length(s) of carriers switching gap for RxU and TxU.

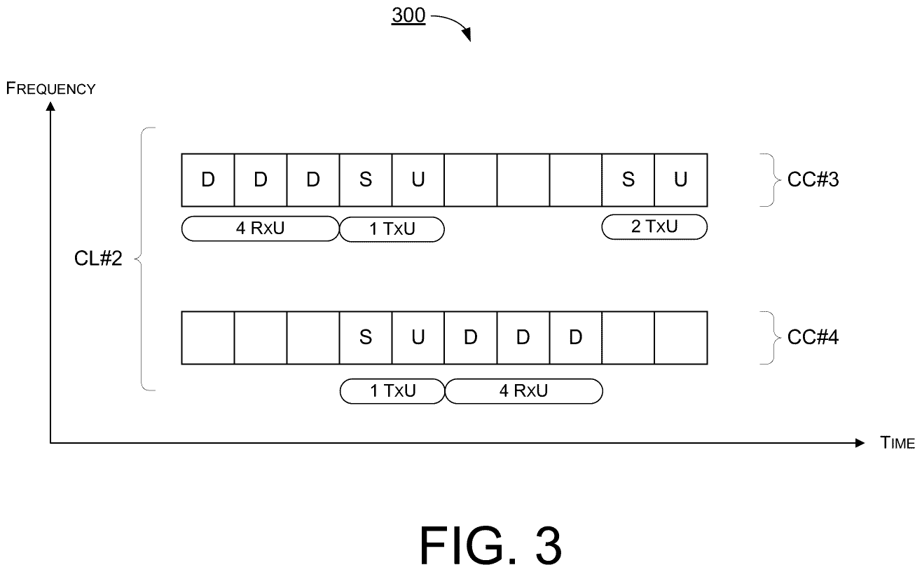

For example, please refer to FIG. 3 which illustrates an example scenario 300 under schemes in accordance with implementations of the present disclosure. In particular, the UE may be compatible with techniques of MIMO and may have four RxUs and two TxUs. The network node may transmit the configuration to the UE. After receiving the configuration, the UE may be configured as four carriers CC #1 to CC #4 associated with one cell CL #2. Two carriers CC #3 and CC #4 may be used as activated carriers for the communication(s) between the network node and the UE.

Regarding a DL (transmission from network node perspective and reception from UE perspective,) the UE may utilize four RxUs to receive data from the network node via the carrier CC #3 within the first three slots (which are symbolized as “D”). Then, the UE may receive a carrier switch pattern or an indication from the network node and communicate with the network node according to the carrier switch pattern or the indication. More specifically, in this example, the UE may switch from the carrier CC #3 to the carrier CC #4 during two slots, and then use four RxUs to receive data from the network node via the carrier CC #4 within the next three slots (which are symbolized as “D”).

Regarding an UL (transmission from UE perspective and reception from network perspective,) the UE may utilize: (1) one TxU to prepare and transmit data to the network node via the carrier CC #3 within two slots (which are symbolized as “S” for data preparation and “U” for data uplink) which follows the first three slots; and (2) the other TxU to prepare and transmit data to the network node via the carrier CC #4 within two slots (which are symbolized as “S” for data preparation and “U” for data uplink) which follows the first three slots. Then, the UE may receive a carrier switch pattern or an indication from the network node and communicate with the network node according to the carrier switch pattern or the indication. More specifically, in this example, regarding the TxU transmitting data via the carrier CC #4, the UE may switch from the carrier CC #4 to the carrier CC #3 during three slots, and then the UE may use two TxUs to prepare and transmit data to the network node via the carrier CC #3 within the next two slots (which are symbolized as “S” for data preparation and “U” for data uplink).

In some cases, TxU(s)/RxU(s) (e.g., idle TxU(s)/RxU(s)) of the UE may be reallocated to an activated carrier with higher transmission rank. In some cases, TxU(s)/RxU(s) (e.g., idle TxU(s)/RxU(s)) of the UE may be reallocated to an activated carrier having UL or DL opportunity (i.e., a carrier can be used for UL or DL transmission/reception). In some cases, TxU(s)/RxU(s) (e.g., idle TxU(s)/RxU(s)) may be reallocated to an activated carrier with low traffic loading.

In some implementations, carrier switching may be performed by the network node and the UE cross different cells. For example, the UE may switch from a carrier associated with a first cell to a carrier associated with a second cell.

In some implementations, the network node may transmit a source reference signal (RS) for time and frequency synchronization on one carrier of carriers associated with the cell. In other words, the UE may receive the source RS for time and frequency synchronization from single carrier of the activated carriers in the cell. Further, because the plurality of carriers associated with the cell may be synchronized within a Timing Advance (TA) group (e.g., across the carriers, there may be the same time/frequency offset,) the source RS transmitted via one carrier of the plurality of carriers may be utilized to derive information of time and frequency synchronization corresponding to the rest carriers of the plurality of carriers.

In some implementations, the network node may transmit an RS for pathloss and UL reference timing on one carrier of the plurality of carriers associated with the cell. In other words, the UE may receive the source RS for pathloss and UL reference timing from single carrier of the activated carriers in the cell. Further, because the plurality of carriers associated with the cell may be synchronized (e.g., across the carriers, there may be the same time/frequency offset,) within a TA group, the source RS transmitted via one carrier of the plurality of carriers may be utilized to derive information of pathloss and UL reference timing corresponding to the rest carriers of the plurality of carriers.

In some embodiments, the network node may configure the UE the behavior of switching between the plurality of carriers for a communication (e.g., transmission/reception) so that the UE may switch between the plurality of carriers for the communication.

In some implementations, the network node may transmit a carrier switch pattern to the UE for the UE to determine a behavior of switching between the plurality of carriers for a communication. In particular, the carrier switch pattern may be transmitted via an RRC configuration. After receiving the carrier switch pattern, the UE may determine the behavior of carrier switching between the plurality of carriers for the communication.

In some cases, the UE may communicate with the network node based on: (1) switching a DL reception and an UL transmission from a first carrier to a second carrier according to the carrier switch pattern; (2) switching the DL reception from the first carrier to the second carrier according to the carrier switch pattern; or (3) switching the UL transmission from the first carrier to the second carrier and switching the DL reception from the second carrier to the first carrier according to the carrier switch pattern.

Accordingly, the network node may communicate with the UE based on: (1) switching the DL transmission and the UL reception from the first carrier to the second carrier according to the carrier switch pattern; (2) switching the DL transmission from the first carrier to the second carrier according to the carrier switch pattern; or (3) switching the UL reception from the first carrier to the second carrier and switch the DL transmission from the second carrier to the first carrier according to the carrier switch pattern.

Moreover, the UE may be compatible with techniques of MIMO and may have ‘n’ number of RxUs and ‘m’ number of TxUs. The network node may transmit carrier switch patterns to the UE. Part of the carrier switch patterns may be for RxUs, and part of the carrier switch patterns may be for TxU. It should be noted that the carrier switch patterns for RxU and TxU may be different for better forward compatibility.

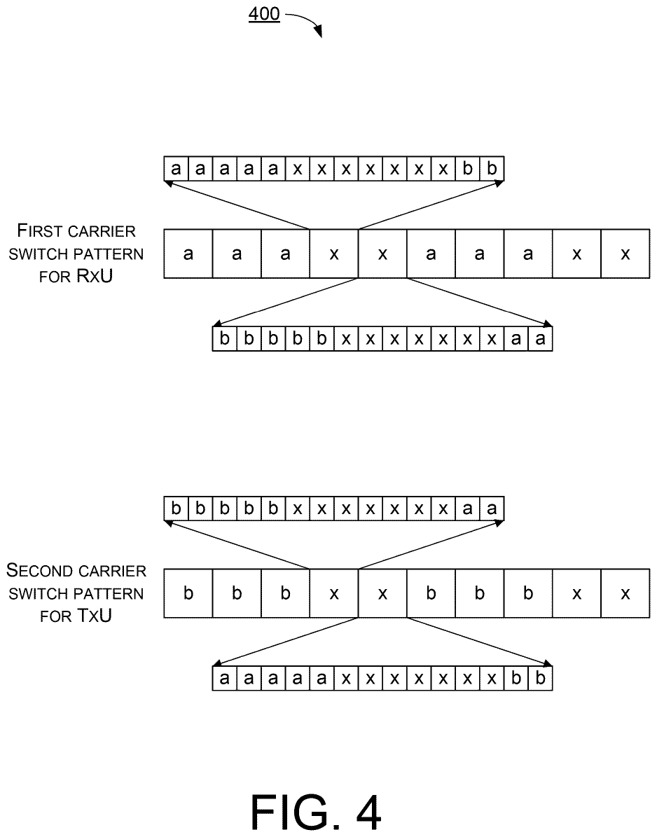

Please refer to FIG. 4 which illustrates an example scenario 400 under schemes in accordance with implementations of the present disclosure. In this example, a first carrier switch pattern for RxUs is configured as slot-level carrier indication and symbol-level carrier indication. There are 10 slots in the first carrier switch pattern. Regarding slot-level, slots labeled with “a” indicates the UE to perform DL reception via carrier CC #a, and slots labeled with “x” indicates the UE to perform carrier switch. Regarding symbol-level, symbols labeled with “a” indicates the UE to perform DL reception via carrier CC #a, symbols labeled with “x” indicates the UE to perform carrier switch, and symbols labeled with “b” indicates the UE to perform DL reception via carrier CC #b.

Further, in this example, a second carrier switch pattern for TxU is configured as slot-level carrier indication and symbol-level carrier indication. There are 10 slots in the second carrier switch pattern. regarding slot-level, slots labeled with “b” indicates the UE to perform UL transmission via carrier CC #b, and slots labeled with “x” indicates the UE to perform carrier switch. Regarding symbol-level, symbols labeled with “b” indicates the UE to perform UL transmission via carrier CC #b, symbols labeled with “x” indicates the UE to perform carrier switch, and symbols labeled with “a” indicates the UE to perform UL transmission via carrier CC #a.

Accordingly, after receiving the first carrier switch pattern and the second carrier switch pattern, the UE may determine the carriers CC #a and CC #b associated with the cell, and (1) utilize two RxUs to perform DL receptions with the network node via the carriers CC #a and CC #b according to the first carrier switch pattern and (2) utilize one TxU to perform UL transmissions with the network node via the carriers CC #a and CC #b according to the second carrier switch pattern.

It should be noted that the network node may configure the UE a specific number for the UE to determine the specific number of RxU(s) to apply the first carrier switch pattern. The network node may configure the UE another specific number for the UE to determine another specific number of TxU(s) to apply the second carrier switch pattern. In some cases, different RxUs or TxUs may apply different carrier switch patterns. It is not intended to limit that all RxUs or TxUs should apply the same carrier switch pattern.

For another example, a third carrier switch pattern for RxUs is configured as slot-level MIMO layer number (i.e., MIMO rank) and symbol-level MIMO layer number. A number of each slot/symbol of the third carrier switch pattern indicates the UE the number of RxUs for performing DL reception per carrier. A fourth carrier switch pattern for TxUs is configured as slot-level MIMO layer number and symbol-level MIMO layer number. A number of each slot/symbol of the fourth carrier switch pattern indicates the UE the number of TxUs for performing UL transmission per carrier. In other words, the network node may configure the UE the certain number of RxUs/TxUs for DL/UL reception/transmission per carrier.

In some implementations, the network node may transmit a layer 1 indication to the UE for the UE to determine a behavior of switching between the plurality of carriers for the communication. In particular, the layer 1 indication may be a physical layer indication transmitted via a downlink control information (DCI) or a Media Access Control (MAC) layer indication transmitted via a MAC-Control Element (MAC-CE). After receiving the layer 1 indication, the UE may determine the behavior of carrier switching between the plurality of carriers for the communication.

In some cases, the UE may communicate with the network node based on: (1) switching a DL reception and an UL transmission from a first carrier to a second carrier according to the layer 1 indication; (2) switching the DL reception from the first carrier to the second carrier according to the layer 1 indication; or (3) switching the UL transmission from the first carrier to the second carrier and switching the DL reception from the second carrier to the first carrier according to the layer 1 indication.

Accordingly, the network node may communicate with the UE based on: (1) switching the DL transmission and the UL reception from the first carrier to the second carrier according to the layer 1 indication; (2) switching the DL transmission from the first carrier to the second carrier according to the layer 1 indication; or (3) switching the UL reception from the first carrier to the second carrier and switching the DL transmission from the second carrier to the first carrier according to the layer 1 indication.

For example, the layer 1 indication is a bit field of DCI (e.g., DCI for scheduling). The bit field of DCI is utilized to indicate carrier switching. In particular, the bit field of DCI is utilized to indicate the UE which carrier the RxU(s) (or the TxU(s)) is (are) switched to.

It should be noted that RxU and TxU may be indicated to switch carrier by different layer 1 indications. It is not intended to limit that all RxUs or TxUs should be indicated to switch carrier by same layer 1 indication.

For another example, carrier switching may be indicated by MIMO layer adaptation. The maximal MIMO layer number is configured per cell. The maximal MIMO layer number is shared across the carriers within one cell.

In some cases, the layer 1 indication may include a timing (e.g., timing in the future) for carrier switching. The timing may be applied: (1) once; (2) until being overwritten; or (3) until being terminated by another command.

### Illustrative Implementations

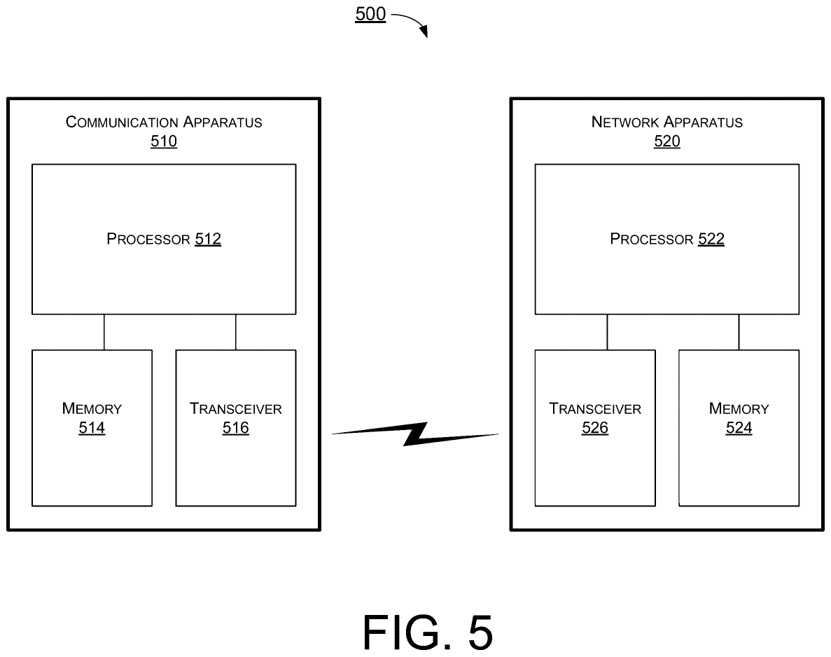

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to carrier switch in cell with respect to user equipment and network apparatus in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, processor 512 may receive, by transceiver 516, a configuration from network apparatus 520. The configuration may include a plurality of carriers associated with a cell. Processor 512 may perform, by transceiver 516, a communication with network apparatus 520 according to at least one carrier associated with the cell. The communication may include at least one of a transmission and a reception. Processor 512 may receive, via transceiver 516, a carrier switch pattern or an indication associated with carrier switching from network apparatus 520. Processor 512 may communicate, via transceiver 516, with network apparatus 520 according to the carrier switch pattern or the indication.

In some implementations, a number of the plurality of carriers associated with the cell is greater than or equal to a maximum carrier number that the apparatus is capable of using.

In some implementations, a number of the at one carrier used for the communication is less than or equal to a maximum carrier number that the apparatus is capable of using.

In some implementations, processor 512 may receive, by transceiver 516, a source RS for time and frequency synchronization from one carrier of the plurality of carriers associated with the cell.

In some implementations, processor 512 may receive, by transceiver 516, a source RS for pathloss and UL reference timing from one carrier of the plurality of carriers associated with the cell.

In some implementations, processor 512 may receive, by transceiver 516, the carrier switch pattern from network apparatus 520 via an RRC configuration.

In some implementations, processor 512 may communicate with network apparatus 520 base on: (1) switching a DL reception and an UL transmission from a first carrier to a second carrier according to the carrier switch pattern; (2) switching the DL reception from the first carrier to the second carrier according to the carrier switch pattern; or (3) switching the UL transmission from the first carrier to the second carrier and switching the DL reception from the second carrier to the first carrier according to the carrier switch pattern.

In some implementations, the indication may include a layer 1 indication.

In some implementations, processor 512 may communicate with network apparatus 520 base on: (1) switching a DL reception and an UL transmission from a first carrier to a second carrier according to the layer 1 indication; (2) switching the DL reception from the first carrier to the second carrier according to the layer 1 indication; or (3) switching the UL transmission from the first carrier to the second carrier and switching the DL reception from the second carrier to the first carrier according to the layer 1 indication.

In some implementations, the layer 1 indication may include a timing for carrier switching, and the timing may be applied: (1) once; (2) until being overwritten; or (3) until being terminated by another command.

In some implementations, processor 522 may transmit, by transceiver 526, a configuration to communication apparatus 510. The configuration may include a plurality of carriers associated with a cell. Processor 522 may perform, by transceiver 526, a communication with communication apparatus 510 according to at least one carrier associated with the cell. The communication may include at least one of a transmission and a reception. Processor 522 may transmit, via transceiver 526, a carrier switch pattern or an indication associated with carrier switching to communication apparatus 510. Processor 522 may communicate, via transceiver 526, with communication apparatus 510 according to the carrier switch pattern or the indication.

In some implementations, a number of the plurality of carriers associated with the cell is greater than or equal to a maximum carrier number that the apparatus is capable of using.

In some implementations, a number of the at least one carrier used for the communication is less than or equal to a maximum carrier number that the apparatus is capable of using.

In some implementations, processor 522 may transmit, by transceiver 526, a source RS for time and frequency synchronization on one carrier of the plurality of carriers associated with the cell.

In some implementations, processor 522 may transmit, by transceiver 526, a source RS for pathloss and uplink reference timing on one carrier of the plurality of carriers associated with the cell.

In some implementations, processor 522 may transmit, by transceiver 526, the carrier switch pattern to communication apparatus 510 via an RRC configuration.

In some implementations, processor 522 may communicate with communication apparatus 510 based on: (1) switching an UL reception and a DL transmission from a first carrier to a second carrier according to the carrier switch pattern; (2) switching the DL transmission from the first carrier to the second carrier according to the carrier switch pattern; or (3) switching the UL reception from the first carrier to the second carrier and switching the DL transmission from the second carrier to the first carrier according to the carrier switch pattern.

In some implementations, the indication may include a layer 1 indication.

In some implementations, processor 522 may communicate with communication apparatus 510 based on: (1) switching an UL reception and a DL transmission from a first carrier to a second carrier according to the layer 1 indication; (2) switching the DL transmission from the first carrier to the second carrier according to the layer 1 indication; or (3) switching the UL reception from the first carrier to the second carrier and switching the DL transmission from the second carrier to the first carrier according to the layer 1 indication.

In some implementations, the layer 1 indication may include a timing for carrier switching, and the timing may be applied: (1) once; (2) until being overwritten; or (3) until being terminated by another command.

### Illustrative Processes

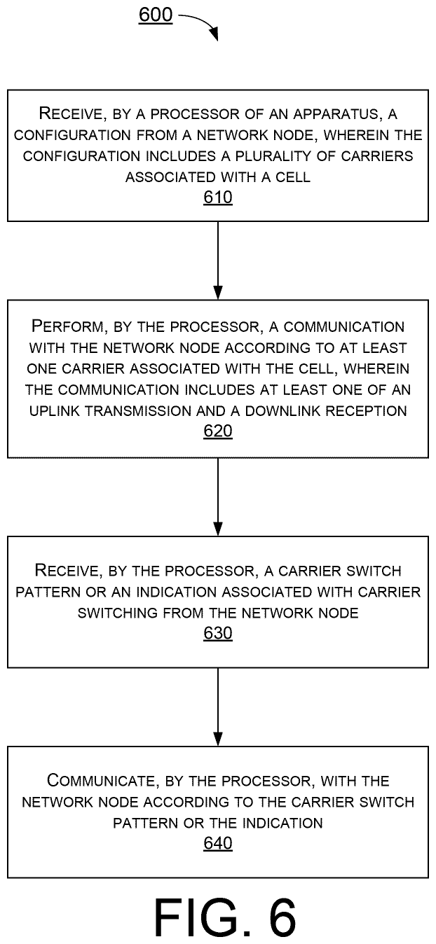

FIG. 6 illustrates an example process 600 in accordance with an implementation of the present disclosure. Process 600 may be an example implementation of above scenarios/schemes, whether partially or completely, with respect to carrier switch in cell of the present disclosure. Process 600 may represent an aspect of implementation of features of communication apparatus 510. Process 600 may include one or more operations, actions, or functions as illustrated by one or more of blocks 610 to 640. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 receiving a configuration from a network node. The configuration includes a plurality of carriers associated with a cell. Process 600 may proceed from block 610 to block 620.

At block 620, process 600 may involve processor 512 of communication apparatus 510 performing a communication with the network node according to at least one carrier associated with the cell. The communication may include at least one of a transmission and a reception. Process 600 may proceed from block 620 to block 630.

At block 630, process 600 may involve processor 512 of communication apparatus 510 receiving a carrier switch pattern or an indication associated with carrier switching from the network node. Process 600 may proceed from block 630 to block 640.

At block 640, process 600 may involve processor 512 of communication apparatus 510 communicating with the network node according to the carrier switch pattern or the indication.

In some implementations, a number of the plurality of carriers associated with the cell is greater than or equal to a maximum carrier number that the apparatus is capable of using.

In some implementations, a number of the at least one carrier used for the communication is less than or equal to a maximum carrier number that the apparatus is capable of using.

In some implementations, process 600 may involve processor 512 receiving a source RS for time and frequency synchronization from one carrier of the plurality of carriers associated with the cell.

In some implementations, process 600 may involve processor 512 receiving a source RS for pathloss and uplink reference timing from one carrier of the plurality of carriers associated with the cell.

In some implementations, process 600 may involve processor 512 receiving the carrier switch pattern from the network node via an RRC configuration.

In some implementations, process 600 may involve processor 512 communicating with the network node based on: (1) switching a DL reception and an UL transmission from a first carrier to a second carrier according to the carrier switch pattern; (2) switching the DL reception from the first carrier to the second carrier according to the carrier switch pattern; or (3) switching the UL transmission from the first carrier to the second carrier and switching the DL reception from the second carrier to the first carrier according to the carrier switch pattern.

In some implementations, the indication may include a layer 1 indication.

In some implementations, process 600 may involve processor 512 communicating with the network node based on: (1) switching a DL reception and an UL transmission from a first carrier to a second carrier according to the layer 1 indication; (2) switching the DL reception from the first carrier to the second carrier according to the layer 1 indication; or (3) switching the UL transmission from the first carrier to the second carrier and switching the DL reception from the second carrier to the first carrier according to the layer 1 indication.

In some implementations, the layer 1 indication may include a timing for carrier switching, and the timing may be applied: (1) once; (2) until being overwritten; or (3) until being terminated by another command.

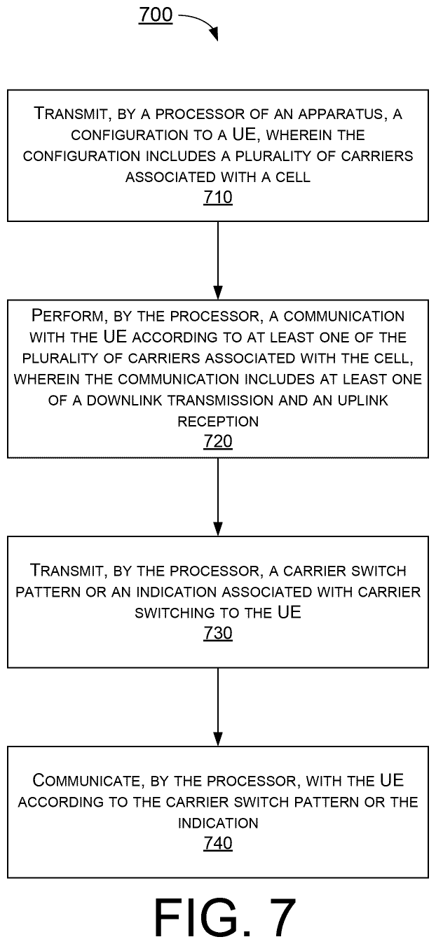

FIG. 7 illustrates an example process 700 in accordance with an implementation of the present disclosure. Process 700 may be an example implementation of above scenarios/schemes, whether partially or completely, with respect to carrier switch in cell of the present disclosure. Process 700 may represent an aspect of implementation of features of network apparatus 520. Process 700 may include one or more operations, actions, or functions as illustrated by one or more of blocks 710 to 740. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any suitable network device or machine type devices. Solely for illustrative purposes and without limitation, process 700 is described below in the context of network apparatus 520. Process 700 may begin at block 710.

At block 710, process 700 may involve processor 522 of network apparatus 520 transmitting a configuration to a UE. The configuration may include a plurality of carriers associated with a cell. Process 700 may proceed from block 710 to block 720.

At block 720, process 700 may involve processor 522 performing a communication with the UE according to at least one carrier associated with the cell. The communication may include at least one of a transmission and a reception. Process 700 may proceed from block 720 to block 730.

At block 730, process 700 may involve processor 522 transmitting a carrier switch pattern or an indication associated with carrier switching to the UE. Process 700 may proceed from block 730 to block 740.

At block 740, process 700 may involve processor 522 communicating with the UE according to the carrier switch pattern or the indication.

In some implementations, a number of the plurality of carriers associated with the cell is greater than or equal to a maximum carrier number that the apparatus is capable of using.

In some implementations, a number of the at least one carrier used for the communication is less than or equal to a maximum carrier number that the apparatus is capable of using.

In some implementations, process 700 may involve processor 522 transmitting a source RS for time and frequency synchronization on one carrier of the plurality of carriers associated with the cell.

In some implementations, process 700 may involve processor 522 transmitting a source RS for pathloss and uplink reference timing on one carrier of the plurality of carriers associated with the cell.

In some implementations, process 700 may involve processor 522 transmitting the carrier switch pattern to the UE via an RRC configuration.

In some implementations, process 700 may involve processor 522 communicating with the UE based on: (1) switching an UL reception and a DL transmission from a first carrier to a second carrier according to the carrier switch pattern; (2) switching the DL transmission from the first carrier to the second carrier according to the carrier switch pattern; or (3) switching the UL reception from the first carrier to the second carrier and switching the DL transmission from the second carrier to the first carrier according to the carrier switch pattern.

In some implementations, the indication may include a layer 1 indication.

In some implementations, process 700 may involve processor 522 communicating with the UE based on: (1) switching an UL reception and a DL transmission from a first carrier to a second carrier according to the layer 1 indication; (2) switching the DL transmission from the first carrier to the second carrier according to the layer 1 indication; or (3) switching the UL reception from the first carrier to the second carrier and switching the DL transmission from the second carrier to the first carrier according to the layer 1 indication.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration from a network node, wherein the configuration includes a plurality of carriers associated with a cell;
performing, by the processor, a communication with the network node according to at least one carrier associated with the cell, wherein the communication includes at least one of an uplink transmission and a downlink reception;
receiving, by the processor, a carrier switch pattern or an indication associated with carrier switching from the network node; and
communicating, by the processor, with the network node according to the carrier switch pattern or the indication.

2. The method of claim 1, wherein a number of the plurality of carriers associated with the cell is greater than or equal to a maximum carrier number that the apparatus is capable of using.

3. The method of claim 1, wherein a number of the at least one carrier used for the communication is less than or equal to a maximum carrier number that the apparatus is capable of using.

4. The method of claim 1, further comprising:
receiving, by the processor, a source reference signal for time and frequency synchronization from one carrier of the plurality of carriers associated with the cell.

5. The method of claim 1, further comprising:
receiving, by the processor, a source reference signal for pathloss and uplink reference timing from one carrier of the plurality of carriers associated with the cell.

6. The method of claim 1, further comprising:
receiving, by the processor, the carrier switch pattern from the network node via a radio resource control (RRC) configuration.

7. The method of claim 6, wherein the step of communicating with the network node according to the carrier switch pattern further comprises:
communicating, by the processor, with the network node based on switching a downlink reception and an uplink transmission from a first carrier to a second carrier according to the carrier switch pattern;
communicating, by the processor, with the network node based on switching the downlink reception from the first carrier to the second carrier according to the carrier switch pattern; or
communicating, by the processor, with the network node based on switching the uplink transmission from the first carrier to the second carrier and switching the downlink reception from the second carrier to the first carrier according to the carrier switch pattern.

8. The method of claim 1, wherein the indication includes a layer 1 indication.

9. The method of claim 8, wherein the step of communicating with the network node according to the indication further comprises:
communicating, by the processor, with the network node based on switching a downlink reception and an uplink transmission from a first carrier to a second carrier according to the layer 1 indication;
communicating, by the processor, with the network node based on switching the downlink reception from the first carrier to the second carrier according to the layer 1 indication; or
communicating, by the processor, with the network node based on switching the uplink transmission from the first carrier to the second carrier and switching the downlink reception from the second carrier to the first carrier according to the layer 1 indication.

10. The method of claim 9, wherein the layer 1 indication further includes a timing for carrier switching, and the timing is applied once, applied until being overwritten or applied until being terminated by another command.

11. A method, comprising:
transmitting, by a processor of an apparatus, a configuration to a user equipment (UE), wherein the configuration includes a plurality of carriers associated with a cell;
performing, by the processor, a communication with the UE according to at least one of the plurality of carriers associated with the cell, wherein the communication includes at least one of a downlink transmission and an uplink reception;
transmitting, by the processor, a carrier switch pattern or an indication associated with carrier switching to the UE; and
communicating, by the processor, with the UE according to the carrier switch pattern or the indication.

12. The method of claim 11, wherein a number of the plurality of carriers associated with the cell is greater than or equal to a maximum carrier number that the UE is capable of using.

13. The method of claim 11, wherein a number of the at least one carrier used for the communication is less than or equal to a maximum carrier number that the UE is capable of using.

14. The method of claim 11, further comprising:
transmitting, by the processor, a source reference signal for time and frequency synchronization on one carrier of the plurality of carriers associated with the cell.

15. The method of claim 11, further comprising:
transmitting, by the processor, a source reference signal for pathloss and uplink reference timing on one carrier of the plurality of carriers associated with the cell.

16. The method of claim 11, further comprising:
transmitting, by the processor, the carrier switch pattern to the UE via a radio resource control (RRC) configuration.

17. The method of claim 16, wherein the step of communicating with the UE according to the carrier switch pattern further comprises:
communicating, by the processor, with the UE based on switching an uplink reception and a downlink transmission from a first carrier to a second carrier according to the carrier switch pattern;
communicating, by the processor, with the UE based on switching the downlink transmission from the first carrier to the second carrier according to the carrier switch pattern; or
communicating, by the processor, with the UE based on switching the uplink reception from the first carrier to the second carrier and switching the downlink transmission from the second carrier to the first carrier according to the carrier switch pattern.

18. The method of claim 11, wherein the indication includes a layer 1 indication.

19. The method of claim 18, wherein the step of communicating with the UE according to the indication further comprises:
communicating, by the processor, with the UE based on switching an uplink reception and a downlink transmission from a first carrier to a second carrier according to the layer 1 indication;
communicating, by the processor, with the UE based on switching the downlink transmission from the first carrier to the second carrier according to the layer 1 indication; or
communicating, by the processor, with the UE based on switching the uplink reception from the first carrier to the second carrier and switching the downlink transmission from the second carrier to the first carrie according to the layer 1 indication.

20. An apparatus, comprising:
a transceiver which, during operation, wirelessly communicates with a network node; and
a processor communicatively coupled to the transceiver such that, during operation, the processor performs operations comprising:
receiving, via the transceiver, a configuration from the network node, wherein the configuration includes a plurality of carriers associated with a cell;
performing, via the transceiver, a communication with the network node according to at least one carrier associated with the cell, wherein the communication includes at least one of a downlink reception and an uplink transmission;
receiving, via the transceiver, a carrier switch pattern or an indication associated with carrier switching from the network node; and
communicating, via the transceiver, with the network node according to the carrier switch pattern or the indication.
